(19) United States
(12) Patent Application Publication
(10) Pub. No.: US 2020/0337345 A1
(43) Pub. Date: Oct. 29, 2020

(54) SURIMI PROCESS WITH A SECOND MINCER BEFORE REFINER

(71) Applicants: Christopher Campbell Riley, Federal Way, WA (US); Ryan Balice, Kodiak, AK (US)

(72) Inventors: Christopher Campbell Riley, Federal Way, WA (US); Ryan Balice, Kodiak, AK (US)

(21) Appl. No.: 16/855,915

(22) Filed: Apr. 22, 2020

Related U.S. Application Data
(60) Provisional application No. 62/837,252, filed on Apr. 23, 2019.

(51) Int. Cl. A23L 17/00; A22C 25/02; A22C 25/18

(52) U.S. Cl. CPC A23L 17/70; A23V 2002/00; A22C 25/18; A22C 25/02

(57) ABSTRACT

A process for making surimi comprises after performing a wash and dewater cycle on fish flesh, bringing the fish flesh to a dry solids content of about 14% by weight, followed by a first refining step of the fish flesh.

### CROSS-REFERENCE(S) TO RELATED APPLICATION(S)

This application claims the benefit of U.S. Provisional Application No. 62/837,252, filed Apr. 23, 2019. This application is expressly incorporated herein by reference.

### BACKGROUND

Surimi is produced by widely varying processes, but nearly all processes include certain basic steps, usually in the following order: deboning, gutting, skinning, and filleting the fish, mincing the fish flesh, washing the fish flesh with water, separating the wash water from the fish flesh, refining the fish flesh to remove impurities and connective tissue, dewatering the fish flesh, blending the fish flesh with cryoprotectants, and freezing the fish flesh. It is to be appreciated that there are variations that can be employed. For example, the wash and separate steps may be performed a multitude of times. In the case where the surimi is expected to be used within a few days of production, the blending and freezing steps would not be necessary. It is also to be appreciated that surimi is an intermediate product. Surimi is used in making a variety of consumer end products such as kamaboko and artificial crabmeat. The major component of surimi is myofibrillar protein. The wash, separate, refine, and dewater steps are aimed at removing impurities in an effort to concentrate the valuable, gel forming myofibrillar protein. Impurities such as blood, cartilage, connective tissue, skin, tendon, ligaments, and water-soluble sarcoplasmic proteins are removed in the wash, separate, and refining steps. The optimal water content can be achieved in the dewater step. An ongoing problem is the loss of the desirable myofibrillar protein with the wash water. The loss of myofibrillar proteins not only reduces the overall yield of surimi product, but the protein is often discarded with the wash water. If the wash water ends up in the ocean, the protein will add to the biochemical oxygen demand (BOD) and result in less dissolved oxygen in the ocean. Reduced oxygen levels in the ocean can lead to the death of aquatic life including fish. Because the myofibrillar proteins are both insoluble and denser than seawater, they sink to the ocean floor where they accumulate. The process of biological oxidation can kill the animals that make up the benthic community through oxygen deprivation.

### SUMMARY

In one embodiment, a process for making surimi comprises after performing a wash and dewater cycle on fish flesh, bringing the fish flesh to a dry solids content of about 14% by weight, followed by a first refining step of the fish flesh.

In one embodiment, the process for making surimi further comprises following the first refining step of the fish flesh, adjusting the water content of the fish flesh to equate to a dry solids content of about 9% by weight.

In one embodiment of the process for making surimi adjusting the water content of the fish flesh includes adding water to the fish flesh.

In one embodiment, the process for making surimi further comprises following adjusting the water of the fish flesh, performing a second refining step of the fish flesh.

In one embodiment of the process for making surimi the second refining step refines fish flesh with a screen hole size larger compared to the first refining step of fish flesh.

In one embodiment, the process for making surimi further comprises following the second refining step of the fish flesh, adjusting the water content of the fish flesh to equate to a dry solids content of about 18% by weight.

In one embodiment, the process for making surimi further comprises before performing a wash and dewater cycle on fish flesh, mincing the fish flesh.

In one embodiment of the process for making surimi mincing the fish flesh comprises passing the fish flesh through screen perforations of about 5 mm in diameter.

In one embodiment, the process for making surimi further comprises before mincing the fish flesh, butchering fish to produce the fish flesh.

In one embodiment, the process for making surimi further comprises after performing a wash and dewater cycle on fish flesh, dewatering the fish flesh to equate to a dry solids content of about 14% by weight.

In one embodiment, the process for making surimi further comprises after performing a wash and dewater cycle on fish flesh, dewatering the fish flesh to equate to a dry solids content in the range of 19% to 22% by weight, and then, adding water to adjust the dry solids content from 19% to 22% by weight to about 14% by weight.

In an embodiment, a system for making surimi comprises a wash section having a perforated drum or screen; a dewater section with a rotary screen or filter belt downstream from the wash section; a screwpress downstream from the dewater section; a first refiner downstream from the screwpress, wherein the first refiner has a perforated screen with perforations; and a second refiner downstream from the first refiner, wherein the second refiner has a perforated screen with perforations smaller than the first refiner.

In an embodiment, the perforations of the first refiner are about 1 mm to 1.4 mm.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a generalized process of producing surimi in a conventional manner;

FIG. 2 is a process of producing surimi in accordance with embodiments of the disclosure; and

FIG. 3 is a modification of the process of FIG. 2 in accordance with embodiments of the disclosure.

### DETAILED DESCRIPTION

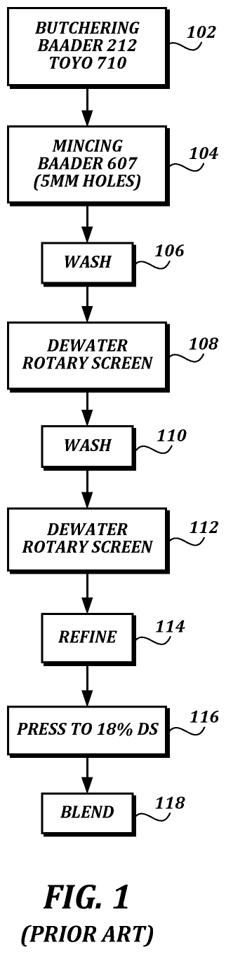

Referring to FIG. 1, a flow diagram of a conventional surimi process is illustrated. In making surimi, the fish is first de-headed, gutted, sometimes filleted, and deboned by using well-known machinery in block 102. In one embodiment, butchering includes removing the head from the body, gutting the fish, and cutting the fish into fillets. A multifunctional machine capable of performing these operations, includes, for example BAADER 212 or TOYO 710. After producing fish fillets, the process enters block 104 from block 102.

After deboning and gutting, the fish flesh is minced in block 104 by well-known machinery, such as by forcing the fish flesh to pass through a perforated steel drum having holes in the range of from 2-7 mm in diameter, and usually from 3-5 mm, in diameter. Many variations of deboning and mincing fish flesh exist. The extent to which the fish is minced is oftentimes dictated by the quality of the surimi desired to be produced or by balancing the amount of fish flesh desired to be recovered versus the cost to recover it. In some operations, the raw material is composed of trimmings, frame meat, or muscle tissue contained in the fish head. In one embodiment, the fish flesh is squeezed through perforations in a steel drum. The size of the perforations determines the texture of the minced meat. Conventionally, 5 mm perforations has been considered standard for surimi. After producing minced fish flesh, the process enters block 106 from block 104.

Generally, all conventional surimi is produced by washing the fish flesh with water, block 106, and then separating the water (dewatering), block 108. Washing the fish flesh with water is used to make surimi, because the wash step removes much of the undesirable water-soluble sarcoplasmic protein, enzymes, and blood, and concentrates the myofibrillar protein. Myofibrillar protein is more desirable because the myofibrillar protein produces the gel-forming ability characteristic of surimi, while the sarcoplasmic protein only detracts from this ability. Many variations of the wash and dewater steps exist. In conventional wash processes, the wash water is combined with fish flesh in a batch, continuous batch, continuous tank, or “pipe” wash. Many times, the wash and dewater steps are performed in the same machinery. For example, a perforated rotating drum spins around its central axis while the wash water is sprayed onto the outside of the drum and mixes with the tumbling fish flesh inside the tank. The spraying is stopped, and then the water is induced to separate from the fish flesh through perforations in the drum as the drum rotates. In an embodiment, a drum can be replaced with one or more screens. The amount of water, the temperature, and the time of the wash and dewater steps can all be adjusted to produce surimi having selected characteristics, such as color and gel-forming ability. FIG. 1 illustrates one embodiment of a process including two wash cycles. The first wash and dewater steps, blocks 106, 108 are followed by a second wash and dewater steps, blocks 110, 112. From the second dewater step, block 112, the process enters block 114.

Block 114 is for refining the washed and dewatered minced fish flesh. The refining step, block 114, uses machinery to further reduce the impurities, such as skin, bone, and connective tissues. The refining step, block 114, can use machinery similar to the machinery used for mincing, block 104. However, in the refining step, block 114, the perforations of the screen are generally on the order of 1 to 2 mm. From the refining step, block 114, the process enters block 116.

Block 116 is for dewatering the refined fish flesh to have a certain water content. Conventionally, the target water content in block 116 equates to 18% (plus/minus 1%) by weight on a dry solids basis. The dewatering step, block 112, may be performed by a conventional screw press or a conventional decanter centrifuge. From the press step, block 116, the process enters block 118.

Block 118 is for optionally blending the refined fish flesh of predetermined water content with cryoprotectants. Cryoprotectants may be used if the fish flesh is to be preserved by freezing. If the fish flesh is not being frozen, then, the fish flesh can proceed to other processes where the surimi forms one ingredient thereof. Known cryoprotectants include sorbitol, sucrose, and phosphates. Cryoprotectants prevent the denaturation of the myofibrillar proteins when frozen. After blending with cryoprotectants in block 118, the fish flesh may be frozen for later use.

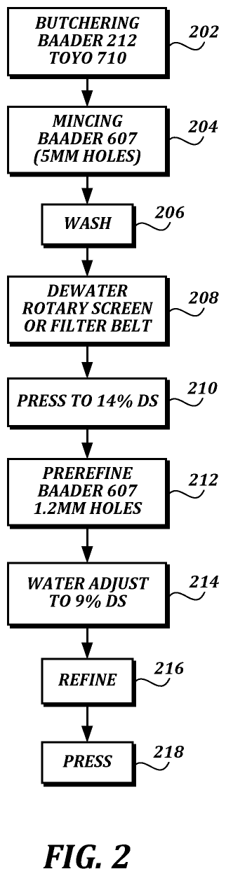

Referring to FIG. 2, a flow diagram according to embodiments of the disclosure is illustrated. The butchering step, block 202 to the dewater step, block 208, can be carried out similar to the conventional process as illustrated in FIG. 1. Even though FIG. 2 illustrates one wash and dewater cycle, blocks 206, 208, a second wash and dewater cycle may be performed in the process of FIG. 2, as shown for the process of FIG. 1.

Referring to FIG. 2, after the dewater step, block 208, whether of a first or second wash cycle, the process of FIG. 2 deviates from the process of FIG. 1. Following the dewater step, block 208, the process of FIG. 2 includes a step for adjustment of the water content to be about 14% (plus/minus 1%) by weight based on a dry solids basis, block 210. Machinery capable of adjusting the water content in block 210, in one embodiment, includes a screwpress. Screwpress screens with 0.5 to 1.5 mm perforations are generally suitable. Following block 210, the process of FIG. 2 enters block 212.

Block 212 is a first refining step (pre-refining step), in which the fish flesh is processed by machinery similar to that used for mincing (BAADER 607). However, in block 212, the screen hole size is on the order of about 1 to 1.4 mm, 1 to 1.2 mm, or about 1.2 mm. Following the first refining step, block 210, the process of FIG. 2 enters block 214.

Block 214 is a second a step for adjustment of the water content to be about 9% (plus/minus 1%) by weight based on a dry solids basis. In block 214 the target water content equates to about 9% based on a dry solids basis. Therefore, in one embodiment, the addition of water may be performed to increase the water content to about 9% based on a dry solids basis. Following block 214, the process of FIG. 2 enters block 216.

Block 216 is a second refining step. The second refining step, block 216, can use machinery similar to the machinery (BAADER 607) used in the first refining step, block 212. However, in the second refining step, block 216, the size of perforations of the screen are generally on the order of 1 mm to 2 mm. In an embodiment, the second refiner 216 has a perforated screen with perforations smaller than the first refiner 212. From the second refining step, block 216, the process enters block 218.

Block 218 is for dewatering the refined fish flesh to have a certain water content. Conventionally, the target water content in block 218 equates to 18% (plus/minus 1%) by weight on a dry solids basis. The dewatering step, block 218, may be performed by a conventional screw press or a conventional decanter centrifuge. From the press step, block 218, the process of FIG. 2 can follow the conventional process after block 116 of FIG. 1. That is, after block 218, the process may include blending with cryoprotectants if the fish flesh is to be frozen, or cyroprotectants can be omitted if the fish flesh is to be used as in an ingredient for other products.

In one embodiment of the method of processing mince, the fish is selected from the group consisting of Alaska Pollock (Theragra chalcogramma), Pacific whiting (Merluccius productus), Atlantic cod (Gadus morhua), Pacific cod (Gadus macrocephalus), Croaker (Pennahia macrocephalus), Bigeye (Priacanthus arenatus), Tilapia (Oreochromis mossambicus), Southern Blue whiting (Micromesistius australis), Blue whiting (Micromesistius poutassou), Basa (Pangasius bocourti), Carp (Cyprinidae spp.), Hake or Cod (Gadidae spp.), Catfishes (order Siluriformes), Atlantic salmon (Salmo salar), Chinook salmon (Oncorhynchus tshawytscha), Chum salmon (Oncorhynchus keta), Coho salmon (Oncorhynchus kisutch), Pink salmon (Oncorhynchus gorbuscha), Sockeye salmon (Oncorhynchus nerka), a Cyprinidae, and a carp, or any combination thereof.

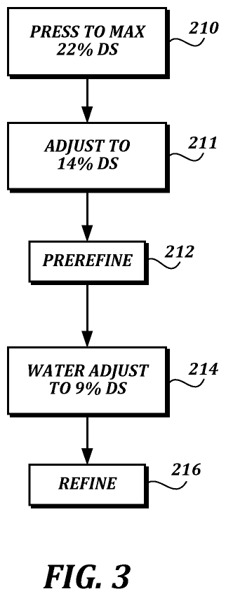

FIG. 3 is a modification of the process of FIG. 2. In FIG. 3, the process is shown starting with block 210. However, the blocks 202, 204, and 206 are also part of the process, but are not illustrated. In the block 210, instead of pressing to achieve about 14% dry solids content by weight, the press cake is dewatered to a dry solids content having a maximum dry solids content of about 22% by weight, or in the range of 19-22% dry solids, or in the range of 20-22% dry solids. Then, from block 210, the process enters block 211, where water is added to the press cake to bring the dry solids content down to 14% by weight. From block 211, the process proceeds with block 212, 214, 216, and 218 as described herein for FIG. 2. This alteration in the process will provide considerable water savings. This alteration can facilitate the very thorough washing that is desired to be performed on recovery grade surimi.

FIG. 2 illustrates a system for making surimi. The system includes downstream from a mincer 204, a wash section 206 having a perforated drum or screen. Downstream from the wash section 206 is a dewater section 208 with a rotary screen or filter belt. Downstream from the dewater section 208 is a screwpress 210. Downstream from the screwpress 210 is a first refiner 212, wherein the first refiner 212 has a perforated screen. Downstream from the first refiner 212 is a second refiner 216, wherein the second refiner has a perforated screen with perforations smaller than the first refiner 212. In an embodiment, the perforations of the first refiner 212 are about 1 mm to 1.4 mm.

While illustrative embodiments have been illustrated and described, it will be appreciated that various changes can be made therein without departing from the spirit and scope of the invention.

The embodiments of the invention in which an exclusive property or privilege is claimed are defined as follows:

1. A process for making surimi, comprising:
after performing a wash and dewater cycle on fish flesh, bringing the fish flesh to a dry solids content of about 14% by weight, followed by a first refining step of the fish flesh.

2. The process of making surimi of claim 1, further comprising:
following the first refining step of the fish flesh, adjusting the water content of the fish flesh to equate to a dry solids content of about 9% by weight.

3. The process of making surimi of claim 2, wherein adjusting the water content of the fish flesh includes adding water to the fish flesh.

4. The process of making surimi of claim 2, further comprising:
following adjusting the water of the fish flesh, performing a second refining step of the fish flesh.

5. The process of making surimi of claim 4, wherein the second refining step refines fish flesh with a screen hole size larger compared to the first refining step of fish flesh.

6. The process of making surimi of claim 4, further comprising:
following the second refining step of the fish flesh, adjusting the water content of the fish flesh to equate to a dry solids content of about 18% by weight.

7. The process of making surimi of claim 1, further comprising:
before performing a wash and dewater cycle on fish flesh, mincing the fish flesh.

8. The process of claim 1, wherein mincing the fish flesh comprises passing the fish flesh through screen perforations of about 5 mm in diameter.

9. The process of claim 1, further comprising:
before mincing the fish flesh, butchering fish to produce the fish flesh.

10. The process of claim 1, further comprising, after performing a wash and dewater cycle on fish flesh, dewatering the fish flesh to equate to a dry solids content of about 14% by weight.

11. The process of claim 1, further comprising, after performing a wash and dewater cycle on fish flesh, dewatering the fish flesh to equate to a dry solids content in the range of 19% to 22% by weight, and then, adding water to adjust the dry solids content from 19% to 22% by weight to about 14% by weight.

12. A system for making surimi, comprising:
a wash section having a perforated drum or screen;
a dewater section with a rotary screen or filter belt downstream from the wash section;
a screwpress downstream from the dewater section;
a first refiner downstream from the screwpress, wherein the first refiner has a perforated screen with perforations; and
a second refiner downstream from the first refiner, wherein the second refiner has a perforated screen with perforations smaller than the first refiner.

13. The system of claim 12, wherein the perforations of the first refiner are about 1 mm to 1.4 mm.
